(19) United States
(12) Patent Application Publication
(10) Pub. No.: US 2008/0270016 A1
(43) Pub. Date: Oct. 30, 2008

(54) Navigation System for a Vehicle

(75) Inventors: John Proietty, Ferndale, MI (US); Ming Kuang, Canton, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 12/066,935

(22) PCT Filed: Nov. 21, 2005
(86) PCT No.: PCT/US05/42343

§ 371 Date: Mar. 14, 2008

(51) Int. Cl. G01C 21/30; G06F 19/00

(52) U.S. Cl. 701/123; 701/201

(57) ABSTRACT

A navigation system and method provides travel routes for a vehicle The method includes receiving an origin (62) destination (66) for the vehicle The method also includes determining a shortest distance route (70), a fastest time route (68), an optimal fuel efficient route, and a fuel economy of each route The method also includes comparing the fuel economy of the shortest distance route, the fastest time route, and the optimal fuel efficient route (82) Additionally, the method includes outputting the fuel economy savings of the shortest distance route, the fastest time route, and the optimal fuel efficient route to a navigation system display (84).

### TECHNICAL FIELD

The present invention generally relates to a vehicle navigation system, and in particular to a system and method for providing fuel efficient routes for a vehicle.

### BACKGROUND

On-board navigation systems for providing route information are commonly available for vehicles. Conventional navigation systems are also adapted to provide routing information and/or instructions to the vehicle operator based on, for example, traffic conditions and fuel consumption. Although conventional systems are capable of providing such routing information, there exists a wide horizon for improvement.

For example, the conventional systems provide routing information pertaining to a minimal number of routes based on a set of pre-specified factors (e.g., traffic conditions and fuel consumption). As such, the operator is not provided multiple alternative travel routes that would enhance the operator's travel options. Furthermore, although fuel consumption and traffic conditions may be considered when providing travel routes, the manner in which these routes are determined is inefficient.

Thus, the present invention was conceived in view of these and other disadvantages of conventional navigation systems.

### SUMMARY

The present invention includes a method and system for electronically providing travel routes for a vehicle through the use of a navigation system. The method includes receiving an origin and a destination for the vehicle. The method also includes determining a shortest distance route between the origin and the destination and a fuel economy of the shortest distance route. The method also includes determining a fastest time route between the origin and the destination and a fuel economy of the fastest time route. The method includes determining an optimal fuel efficient route between the origin and the destination and a fuel economy of the optimal fuel efficient route. The method includes comparing the fuel economy of the shortest distance route, the fastest time route, and the optimal fuel efficient route and outputting the fuel economy savings of each route.

The system for electronically providing travel routes for a vehicle is configured to receive the origin and destination of the vehicle. The system is configured to determine a shortest distance route, a fastest time route, and an optimal fuel efficient route between the origin and the destination and determine a fuel economy of each route. The system is further configured to compare the fuel economy of the shortest distance route, the fastest time route, and the optimal fuel efficient route and output the fuel economy savings of each route.

The above embodiments and other embodiments, features, and advantages of the present invention are readily apparent from the following detailed description of the best mode for carrying out the invention when taken in connection with the accompanying drawings.

### BRIEF DESCRIPTION OF THE DRAWINGS

The features of the present invention which are believed to be novel are set forth with particularity in the appendant claims. The present invention, both as to its organization and manner of operation, together with further objects and advantages thereof, may be best understood with reference to the following description, taken in connection with the accompanying drawings in which;

FIG. 1 depicts a vehicle having a navigation system in accordance with an embodiment of the present invention; and

FIG. 2 illustrates a flow diagram of a method for providing travel routes for a vehicle in accordance with an embodiment of the present invention.

### DETAILED DESCRIPTION OF THE PREFERRED EMBODIMENT(S)

By way of example, a preferred system and methodology for implementing the present invention is described below. The provided system and methodology may be adapted, modified or rearranged to best-fit a particular implementation without departing from the scope of the present invention.

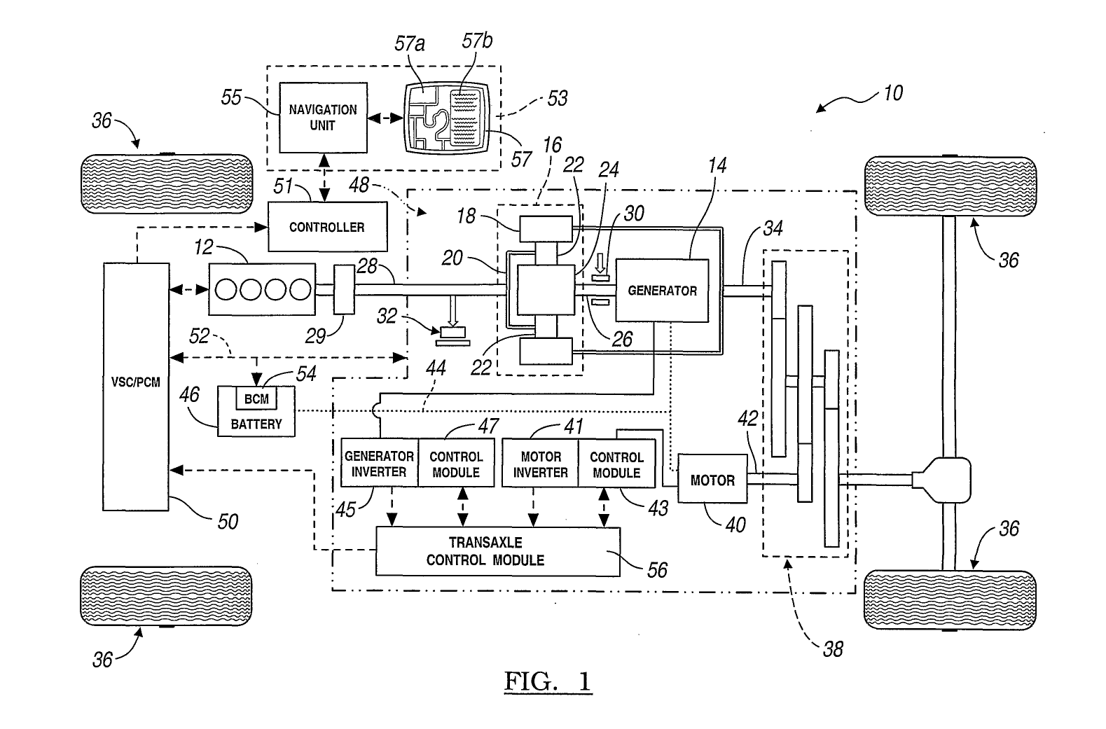

FIG. 1 illustrates a schematic representation of a vehicle 10 in accordance with one embodiment of the present invention. The vehicle 10 includes an engine 12 and an electric machine, or generator 14. The engine 12 and the generator 14 are connected through a power transfer unit, which in this embodiment is a planetary gear set 16. Of course, other types of power transfer units, including other gear sets and transmissions, may be used to connect the engine 12 to the generator 14. The planetary gear set includes a ring gear 18, a carrier 20, planet gears 22, and a sun gear 24.

The generator 14 can also be used as a motor, outputting torque to a shaft 26 connected to the sun gear 24. Similarly, the engine 12 outputs torque to a shaft 28 connected to the carrier 20. A damper 29 is coupled to the shaft 28 and is configured to isolate the planetary gear set 16 from fluctuations in the output torque of the engine 12. In one embodiment, the shaft 28 is comprised of two separate shafts that are coupled together by the damper 29.

A brake 30 may be, but not necessarily provided for stopping rotation of the shaft 26, thereby locking the sun gear 24 in place. Because this configuration allows torque to be transferred from the generator 14 to the engine 12, a one-way clutch 32 may be provided so that the shaft 28 rotates in only one direction. Having the generator 14 operatively connected to the engine 12, as shown in FIG. 1, allows the speed of the engine 12 to be controlled by the generator 14.

The ring gear 18 is connected to a shaft 34, which is connected to vehicle drive wheels 36 through a second gear set 38. The vehicle 10 includes a second electric machine, or motor 40, which can be used to output torque to a shaft 42. Other vehicles within the scope of the present invention may have different electric machine arrangements, such as more or less than two electric machines. In the embodiment shown in FIG. 1, the motor 40 and the generator 14 can both be used as motors to output torque. Alternatively, each can also be used as a generator, outputting electrical power to a high voltage bus 44 and to an energy storage device, or battery 46.

The battery 46 is a high voltage battery that is capable of outputting electrical power to operate the motor 40 and the generator 14. Other types of energy storage devices and/or output devices can be used with a vehicle, such as the vehicle 10. For example, a device such as a capacitor can be used, which, like a high voltage battery, is capable of both storing and outputting electrical energy. Alternatively, a device such as a fuel cell may be used in conjunction with a battery and/or capacitor to provide electrical power for the vehicle 10.

As shown in FIG. 1, the motor 40, the generator 14, the planetary gear set 16, and a portion of the second gear set 38 may generally be referred to as a transaxle 48. The transaxle 48 is analogous to a transmission in a conventional vehicle. Thus, when a driver selects a particular gear, the transaxle 48 is appropriately controlled to provide that gear. To control the engine 12 and the components of the transaxle 48—e.g., the generator 14 and motor 40—a control system, including a first controller 50, is provided. As shown in FIG. 1, the controller 50 is a combination vehicle system controller and powertrain control module (VSC/PCM). Although it is shown as a single hardware device, it may include multiple controllers in the form of multiple hardware devices, or multiple software controllers within one or more hardware devices.

A controller area network (CAN) 52 allows the VSC/PCM 50 to communicate with the transaxle 48 and a battery control mode (BCM) 54. Just as the battery 46 has the BCM 54, other devices controlled by the VSC/PCM 50 may have their own controllers. For example, an engine control unit (ECU) may communicate with the VSC/PCM 50 and may perform control functions on the engine 12. In addition, the transaxle 48 may include one or more controllers, such as a transaxle control module (TCM) 56, configured to control specific components within the transaxle 48, such as the generator 14 and/or the motor 40. Accordingly, as shown in FIG. 1, the TCM 56 communicates with a generator inverter 45 and a motor inverter 41. In one embodiment, the generator inverter 45 and the motor inverter 41 are each coupled to a control module 47 and a control module 43, respectively. Control modules 43 and 47 are capable of converting raw vehicle sensor data readings to a format compatible with the TCM 56 and sending those readings to the TCM 56.

Although the vehicle 10, shown in FIG. 1, is an HEV, it is understood that the present invention contemplates the use of other types of vehicles. In addition, although the vehicle 10 shown in FIG. 1 is a parallel-series HEV, the present invention is not limited to HEV's having such a “powersplit” configuration.

CAN 52 also enables VSC/PCM 50 to communicate with a second controller 51. Controller 51 is configured to process and store data from vehicle systems (e.g., vehicle accessories) of vehicle 10 including a navigation system 53. Navigation system 53, which includes a display 57 and a navigation unit 55, is adapted to provide travel routes for vehicle 10 based on an analysis of various predetermined factors. These predetermined factors may include, but are not limited to topographical features, vehicle accessory operation, vehicle average fuel economy, and road conditions. Furthermore, navigation system 53 may provide the vehicle operator multiple travel routes that include a shortest distance route, a fastest time route, and an optimal fuel efficient route.

The travel routes provided to the vehicle operator are displayable on display 57. Display 57 includes a map section 57a and a text section 57b. It is recognized that the illustrated map and text sections 57a and 57b are merely exemplary and may be modified and adapted without departing from the scope of the present invention. Display 57 may display maps of selected geographic areas within map section 57a. Text section 57b is configured to display travel routes in a textual form for the vehicle operator. Additionally, display 57 may be a touch screen and may include function buttons that are mounted thereon, which enable the input of commands and/or data from the vehicle operator. For example, a vehicle operator may select a preferred travel route by touching a button displayed on display 57. Furthermore, display 57 may have speakers integrated thereto for outputting travel routes to the vehicle operator in the form of voice commands. Accordingly, display 53 is operable with navigation unit 55 for receiving, displaying, and outputting map data and related information.

Navigation unit 55 may have data storage and processing functionality that enables the storage of geographic data pertaining to various locations. The data maintained by navigation unit 55 may include data related to the topographical features of a particular area. In one embodiment, navigation unit 55 has a disc drive in which to receive discs (e.g. compact discs) having geographic information. Accordingly, the information/data stored on the discs is displayable on the display 57. Navigation unit 55 also receives data from controller 51 pertaining to the operation of vehicle accessories (e.g., the heater, defroster, air conditioner, etc.). As recognized by one of ordinary skill in the art, the operation of the vehicle accessories affects various vehicle operation parameters such as fuel economy. Thus, the routes provided by the navigation system 53 are determined based on these and other factors that affect fuel economy. Particularly, upon receiving and analyzing the vehicle accessory data, topographical data, and traffic conditions, the navigation unit 55 and the controllers 50 and 51 are configured to determine the shortest distance route, the fastest time route, and the optimal fuel efficient route. Additionally, the navigation unit 55 and controllers 50 and 51 are capable of determining and comparing the fuel economy of each route. Accordingly, as will be described in detail hereinafter, these routes and fuel economy savings of each route may be displayed on the display 57.

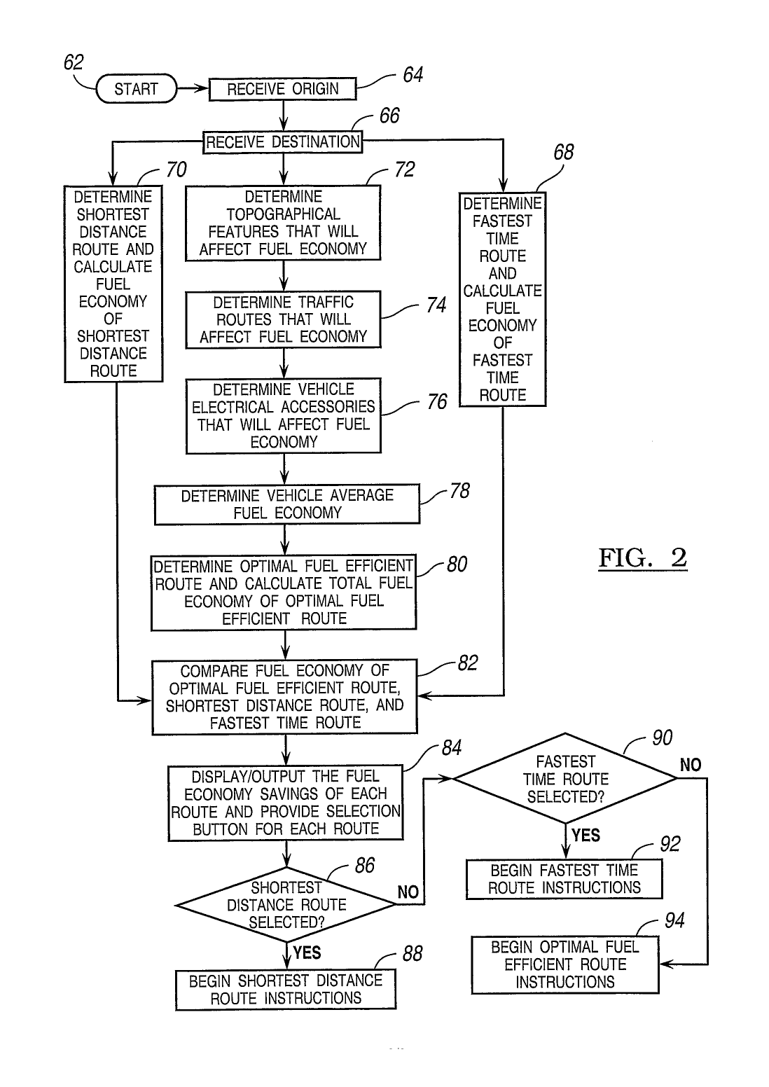

Now referring to FIG. 2, a flow diagram illustrates a method of providing travel routes for a vehicle. Block 62 is the entry point into the method. As depicted by block 64, the navigation system receives an origin for the vehicle. Accordingly, a destination is input through the use of the navigation system display as depicted by block 66. As recognized by one of ordinary skill in the art, the origin and destination may be input into the navigation system 53 by touching the display 57 and following a series of prompts that appear. Based on the received origin and destination information, the navigation system determines the shortest distance route between the origin and the destination. Furthermore, the fuel economy of the shortest distance route is calculated as shown in block 70. In one non-limiting embodiment, the shortest distance route is the shortest route in terms of the actual mileage and/or distance between the origin and destination. Additionally, based on the received origin and destination information, the method is configured to calculate a fastest time route as depicted by block 68. As such, the fuel economy of the fastest time route is calculated as shown by block 68. In one non-limiting embodiment, the fastest time route is determined taking into consideration the type of roads (e.g., freeway, residential streets, etc.) to be traveled as well as the mileage between the origin and the destination.

As depicted by block 72, the method, through the use of navigation system 53, determines the topographical features that will affect the fuel economy of the vehicle. Such topographical features may include the altitude, the slope of road segments, and the elevation of the roads to be traveled. Block 74 illustrates determination of traffic routes that will affect fuel economy. In block 74, the navigation system is adapted to consider traffic congestion, toll roads, and the like when analyzing the traffic routes. Block 76 depicts the method determining which vehicle electrical accessories that will affect the fuel economy of the vehicle. Accordingly, the navigation system receives data from vehicle accessories such as the air conditioning system, the heater, the defroster and the like. As depicted by block 78, the vehicle average fuel economy is determined. The average fuel economy may be the calculated fuel economy over a predetermined amount of time. Based on the average fuel economy, the optimal fuel efficient route is determined as shown in block 80. As illustrated, the optimal fuel efficient route may be, but not necessarily, determined based upon factors including the total fuel economy, the topographical features that affect fuel economy, and traffic routes that may affect the fuel economy. As such, the total fuel economy of the optimal fuel efficient route may be calculated as shown in block 80. In one embodiment, the total fuel economy may be calculated based on the following equation:

Total Fuel Economy=(Avg. Fuel Economy)−Σ (Vehicle Accessory_{Impact});

where “Avg. Fuel Economy” is the average fuel economy as determined at block 78 and “Σ(Vehicle Accessory_{Impact})” is the sum of the vehicle accessories' impact on fuel economy.

The method is further configured to compare the fuel economy of the shortest distance route, the fastest time route, and the optimal fuel efficient route as shown in block 82. It is recognized that in some instances, the optimal fuel efficient route may actually be the same route as the shortest distance route or the fastest time route. Accordingly, the navigation system is configured to determine whether the optimal fuel efficient route is the same route as the shortest distance route or the fastest time route, such that redundant travel routes are not provided to the vehicle operator. As depicted by block 84, the navigation system displays and/or outputs the fuel economy savings of each route to the driver via the navigation system display. Additionally, the driver may be provided selection buttons in which to select a preferred travel route. The selection buttons may be displayed on the display thereby enabling the vehicle operator to simply touch the button that corresponds to the preferred travel route.

As depicted by block 86, the method determines whether the shortest distance route has been selected. If the shortest distance route is selected, the navigation system provides the shortest distance route to the operator as shown in block 88. If the shortest distance route is not selected, block 90 occurs. At block 90, the method determines whether the fastest time route has been selected. If the fastest time route is selected, the navigation system provides the fastest time route to the operator as shown in block 92. If the fastest time route is not selected, block 94 occurs. At block 94, the method provides the optimal fuel efficient route instructions to the vehicle operator. As described above, the travel route instructions provided at blocks 88, 92, and 94 may be displayed in the form of a map, a textural list of instructions, and/or voice commands.

While the best mode for carrying out the invention has been described in detail, those familiar with the art to which this invention relates will recognize various alternative designs and embodiments for practicing the invention as defined by the following claims.

What is claimed:

1. A method for electronically providing travel routes for a vehicle through the use of a navigation system, the method comprising:
receiving an origin for the vehicle via the navigation system;
receiving a destination for the vehicle via the navigation system;
determining a shortest distance route between the origin and the destination and a fuel economy of the shortest distance route;
determining a fastest time route between the origin and the destination and a fuel economy of the fastest time route;
determining an optimal fuel efficient route between the origin and the destination and the total fuel economy of the optimal fuel efficient route; and
comparing the fuel economy of the shortest distance route, the fastest time route, and the optimal fuel efficient route via the navigation system.

2. The method according to claim 1, further comprising displaying the fuel economy savings of the shortest distance route, the fastest time route, and the optimal fuel efficient route through the use of a display that is operable with the navigation system.

3. The method according to claim 2, further comprising selecting a preferred route via the display from the shortest distance route, the fastest time route, and the optimal fuel efficient route subsequent to displaying the fuel economy savings of shortest distance route, the fastest time route, and the optimal fuel efficient route.

4. The method according to claim 3, further comprising displaying the preferred route in the form of a map via the display.

5. The method according to claim 3, further comprising displaying the preferred route in the form of a textual list of instructions or voice commands.

6. The method according to claim 1, wherein determining the optimal fuel efficient route includes evaluating predetermined factors that affect fuel economy of the vehicle via the navigation system.

7. The method according to claim 6, further including calculating a fuel economy of the vehicle based on the predetermined factors.

8. The method according to claim 7, wherein the predetermined factors include topographical features, vehicle accessory operation, vehicle average fuel economy, and road conditions.

9. The method according to claim 1, wherein determining the shortest distance route includes calculating the shortest distance route.

10. The method according to claim 1, wherein determining the fastest time route includes calculating the fastest time route.

11. A system for electronically providing travel routes for a vehicle through the use of a navigation system, wherein the system is configured to:
receive an origin for the vehicle;
receive a destination for the vehicle;
determine a shortest distance route between the origin and the destination and a fuel economy of the shortest distance route;
determine a fastest time route between the origin and the destination and a fuel economy of the fastest time route;
determine an optimal fuel efficient route between the origin and the destination and a fuel economy of the optimal fuel efficient route; and
compare the fuel economy of the shortest distance route, the fastest time route, and the optimal fuel efficient route.

12. The system according to claim 11, wherein the system is further configured to:
display the fuel economy savings of the shortest distance route, the fastest time route, and the optimal fuel efficient route via a display that is operable with the navigation system.

13. The system according to claim 12, wherein the system is further configured for selecting a preferred route, via the display, from the shortest distance route, the fastest time route, and the optimal fuel efficient route subsequent to displaying the fuel economy savings.

14. The system according to claim 13, wherein the system is configured to display the preferred route in the form of at least one of a map, a textual list of instructions and voice commands.

15. The system according to claim 11, wherein the system is configured to determine the optimal fuel efficient route by evaluating predetermined factors that affect fuel economy of the vehicle.

16. The system according to claim 15, wherein the system is configured to evaluate predetermined factors that affect fuel economy by calculating a fuel economy of the vehicle based on the predetermined factors.

17. The system according to claim 16, wherein the system is configured to evaluate predetermined factors that include topographical features, vehicle accessory operation, and road conditions.

18. The system according to claim 11, wherein the system is configured to determine the shortest distance route by calculating the shortest distance route.

19. The system according to claim 11, wherein the system being configured to determine the fastest time route includes the system being configured to determine the fastest time route by calculating the fastest time route.

20. A method for electronically providing travel routes for a hybrid-electric vehicle (HEV) through the use of a navigation system, the method comprising:
receiving an origin for the vehicle;
receiving a destination for the vehicle;
determining a shortest distance route between the origin and the destination and a fuel economy of the shortest distance route;
determining a fastest time route between the origin and the destination a fuel economy of the fastest time route;
determining an optimal fuel efficient route between the origin and the destination a fuel economy of the optimal fuel efficient route;
comparing the fuel economy of shortest distance route, the fastest time route, and the optimal fuel efficient route;
outputting fuel economy savings of the shortest distance route, the fastest time route, and the optimal fuel efficient route to a display;
providing a selection button for selecting a preferred route; and
outputting the preferred route in the form of a textual list of instructions and/or a map.
